(19) United States
(12) Patent Application Publication
(10) Pub. No.: US 2026/0154860 A1
(43) Pub. Date: Jun. 4, 2026

(54) IMAGE GENERATION METHOD AND APPARATUS, DEVICE, MEDIUM AND PRODUCT

(71) Applicants: Beijing Zitiao Network Technology Co., Ltd., Beijing (CN); BEIJING YOUZHUJU NETWORK TECHNOLOGY CO., LTD., Beijing (CN)

(72) Inventors: li’ao QU, Beijing (CN); Huichao ZHANG, Beijing (CN); Yiheng LIU, Beijing (CN); Xu WANG, Beijing (CN); Yi JIANG, Beijing (CN); Yiming GAO, Beijing (CN); Hu YE, Beijing (CN); Kang DU, Beijing (CN); Zehuan YUAN, Beijing (CN); Xinglong WU, Beijing (CN)

(21) Appl. No.: 19/402,119

(22) Filed: Nov. 26, 2025

(30) Foreign Application Priority Data
Nov. 29, 2024 (CN) 202411748455.1

(51) Int. Cl. G06T 11/00; G06F 40/242; G06F 40/284; G06F 40/30

(52) U.S. Cl. CPC G06T 11/00; G06F 40/242; G06F 40/284; G06F 40/30

(57) ABSTRACT

The present application discloses an image generation method and apparatus, a device, a medium and a product. The method includes a process of predicting a token sequence under a plurality of scales, and the process of predicting a token sequence under each scale is obtained through multiple rounds of sampling prediction, so as to realize a later round of sampling prediction on the basis of a result obtained from an earlier round of sampling prediction under the same scale so that the later round of sampling prediction may acquire an associated relationship between different local areas (for example, different local areas represented by different tokens) from the result.

### CROSS REFERENCE TO RELATED APPLICATIONS

This application is based on and claims priority of CN application with application No. 202411748455.1 filed on Nov. 29, 2024, the entire disclosure of which is incorporated herein by reference.

### TECHNICAL FIELD

The present application relates to the field of data processing technology, in particular to an image generation method and apparatus, a device, a medium and a product.

### BACKGROUND

For some scenes, these scenes are present with the following requirements: an image is generated according to a text provided by the user, so that the image satisfies the constraints described by the text.

However, how to realize the above-described image generation process is an urgent technical problem to be solved.

### SUMMARY

In order to solve the above-described technical problem, the present application provides an image generation method and apparatus, a device, a medium and a product, which is beneficial to improving the image generation effect.

In order to achieve the above-described object, the technical solution provided by the present application is as follows:

The present application provides an image generation method. The method comprises: obtaining a target text and a dictionary, wherein the dictionary includes a plurality of visual features and a token of each visual feature; for any scale of a plurality of scales, predicting a corresponding probability of each token under the scale according to reference data corresponding to the scale, wherein the reference data includes the target text; determining a token prediction result of the scale according to sampling parameters and a corresponding probability of each token under the scale, wherein the sampling range indicated by the sampling parameters includes a token prediction result of the scale; updating the reference data corresponding to the scale according to the token prediction result of the scale, wherein the updated reference data includes a token prediction result, and continuing to perform the step of predicting a corresponding probability of each token under the scale according to the reference data corresponding to the scale until a preset stop condition is reached; and generating an image described by the target text according to the visual features indicated in the dictionary by the token prediction results of the plurality of scales.

In one possible embodiment, after the determining a token prediction result of the scale, the method further comprises: updating the sampling parameters, wherein the sampling range indicated by the updated sampling parameters is smaller than that indicated by the sampling parameters before updating.

In one possible embodiment, the preset stop condition includes that: the sampling range indicated by the sampling parameters before updating is not greater than a preset range threshold.

In one possible embodiment, the preset stop condition includes that: the updating times of the reference data corresponding to the scale reach a preset times threshold.

In one possible embodiment, the updating the reference data corresponding to the scale according to the token prediction result of the scale includes: for any scale of a plurality of scales, if that scale is greater than a preset scale threshold, and/or the token prediction result of the scale includes at least two tokens, the reference data corresponding to the scale is updated according to the token prediction result of the scale.

In one possible embodiment, the plurality of scales include a first scale and a second scale, the arrangement position of the first scale among the plurality of scales is adjacent to that of the second scale among the plurality of scales, and the arrangement position of the first scale among the plurality of scales is earlier than that of the second scale among the plurality of scales; and the initial value of the reference data corresponding to the second scale is determined according to the target text and the token prediction result of the first scale.

In one possible embodiment, the image is generated using a decoder; the decoder and the plurality of visual features are determined using the same training process.

The present application provides an image generation apparatus. The apparatus comprises: an obtaining unit configured to obtain a target text and a dictionary, wherein the dictionary includes a plurality of visual features and a token of each visual feature; a processing unit configured to, for any scale of a plurality of scales, predict a corresponding probability of each token under the scale according to reference data corresponding to the scale, wherein the reference data includes the target text; determine a token prediction result of the scale according to sampling parameters and a corresponding probability of each token under the scale, wherein the sampling range indicated by the sampling parameters includes a token prediction result of the scale; and update the reference data corresponding to the scale according to the token prediction result of the scale, wherein the updated reference data includes a token prediction result, and continue to perform the step of predicting a corresponding probability of each token under the scale according to the reference data corresponding to the scale until a preset stop condition is reached; and a generation unit configured to generate an image described by the target text according to the visual features indicated in the dictionary by the token prediction results of the plurality of scales.

The present application provides an electronic device. The electronic device comprises: a processor and a memory; the memory is used to store instructions or computer programs; and the processor is used to execute the instructions or computer programs in the memory, so as to cause the electronic device to perform the image generation method provided by the present application.

The present application provides a computer-readable medium. The computer-readable medium has instructions or computer programs stored thereon that, when run on a device, cause the device to perform the image generation method provided by the present application.

The present application provides a computer program product. The computer program product includes a computer program carried on a non-transitory computer-readable medium, wherein the computer program contains program codes for performing the image generation method provided by the present application.

### BRIEF DESCRIPTION OF THE DRAWINGS

In order to more explicitly explain the technical solutions in the embodiments of the present application or the relevant art, the accompanying drawings required to be used in the description of the embodiments or the relevant art will be briefly introduced below. Obviously, the accompanying drawings described below are merely some of the embodiments of the present application. For those of ordinary skill in the art, other accompanying drawings may also be obtained according to these accompanying drawings on the premise that no inventive effort is involved.

FIG. 1 is a flowchart of an image generation method provided by an embodiment of the present application;

FIG. 2 is a schematic view of multiple rounds of sampling prediction under the same scale provided by an embodiment of the present application;

FIG. 3 is a schematic view of an image generation process provided by an embodiment of the present application;

FIG. 4 is a schematic view of a training flow of a decoder provided by an embodiment of the present application;

FIG. 5 is a schematic structural view of an image generation apparatus provided by an embodiment of the present application;

FIG. 6 is a schematic structural view of an electronic device provided by an embodiment of the present application.

### DETAILED DESCRIPTION

It has been found through studies that, for some text-to-image solutions, for example, an autoregressive image generation solution based on the next token prediction, the solution is generated one token by one token, for example, from left to right and from top to bottom in the form of raster scan, so that there is a large number of steps during the image generation process realized by this solution, which leads to a very slow reasoning speed.

It has also been found through studies that, in order to improve the reasoning speed, image generation processing may be performed using a solution based on next-scale prediction, so as to allow that the solution may realize image generation in a coarse-to-fine manner, so that the solution not only conforms to the painting logic of the real world, but also greatly accelerates the reasoning speed.

It has been further found through studies that, the solution shown in the above paragraph is present with the following defects: when the solution is realized using a top-k top-p sampling strategy, multiple tokens need to be predicted at some scales (for example, 4 tokens need to be predicted at 2×2 scale and 9 tokens need to be predicted at 3×3 scale, etc.), and the prediction processes of different tokens are completely independent, so as to allow that the samples obtained by top-k top-p sampling are independent and irrelevant from each other when different tokens are predicted, so that different tokens might eventually choose the same token (for example, the token for representing the head). Further, it is likely to lead to some problems, for example, it is likely to result in image crash and it is likely to produce repeated parts (for example, a phenomenon of multiple heads or multiple hands in an image), thereby affecting the image generation effect.

It is to be noted that, the top-k top-p sampling strategy is specifically as follows: when prediction is performed for one token, if the prediction probability of each candidate (for example, feature vectors of various image information) is obtained, these candidates are first sorted according to these prediction probabilities to obtain a sorting result; then, the top k candidates are selected from the sorting result, and a plurality of candidates with the highest ranking, whose probability sum reaches the threshold p, are selected from the sorting result; next, the intersection between the top k candidates and the plurality of candidates is taken as a sampling result, so that a sample may be randomly selected from the sampling result to determine a prediction result for the token subsequently.

It is also to be noted that, the token is a symbol, so that it may be used to present a basic unit under certain data (for example, a unit such as vocabulary in a text or an image block in an image). For example, the token may be implemented similar to that in a dictionary (for example, a glossary or a code book), so that the token may participate in some data processing processes on behalf of the entries (for example, vocabulary or a discrete feature) indicated by the token in the dictionary.

Based on the above-described studies, in order to better improve the image generation effect, the present application provides an optimized solution of multiple rounds of sampling prediction for the image generation solution based on next-scale prediction, and the solution comprises: for a token sequence at each scale, the process of predicting a token sequence is obtained through multiple rounds of sampling prediction, so as to realize a later round of sampling prediction on the basis of a result obtained from an earlier round of sampling prediction under the same scale so that the later round of sampling prediction may acquire an associated relationship between different local areas represented by different tokens from the result, thereby effectively overcoming the defects caused by the independent sampling prediction processes of different tokens, so as to obtain a more accurate result in the later round of sampling prediction, which is beneficial to improving the image generation effect.

It may be seen that, the image generation method provided by the present application comprises: obtaining a target text and a dictionary, wherein the dictionary includes a plurality of visual features and a token of each visual feature; for any scale of a plurality of scales, predicting a corresponding probability of each token under the scale according to reference data corresponding to the scale, wherein the reference data includes the target text; determining a token prediction result of the scale according to sampling parameters and a corresponding probability of each token under the scale, wherein the sampling range indicated by the sampling parameters includes a token prediction result of the scale; updating the reference data corresponding to the scale according to the token prediction result of the scale, wherein the updated reference data includes a token prediction result, and continuing to perform the step of predicting a corresponding probability of each token under the scale according to the reference data corresponding to the scale until a preset stop condition is reached; and generating an image described by the target text according to the visual features indicated in the dictionary by the token prediction results of the plurality of scales.

In order to allow those skilled in the art to better understand the solution of the present application, the technical solution in the embodiments of the present application will be explicitly and completely described below in conjunction with the accompanying drawings in the embodiments of the present application. Apparently, the described embodiments are some of the embodiments of the present application, rather than all the embodiments. On the basis of the embodiments of the present application, all the other embodiments obtained by those skilled in the art on the premise that no inventive effort is involved shall fall into the protection scope of the present application.

Compared with the related art, the present application has at least the following advantages:

The image generation solution provided by the present application includes a process of predicting a token sequence under a plurality of scales, and the process of predicting a token sequence under each scale is obtained through multiple rounds of sampling prediction, so as to realize a later round of sampling prediction on the basis of a result obtained from an earlier round of sampling prediction under the same scale so that the later round of sampling prediction may acquire an associated relationship between different local areas (for example, different local areas represented by different tokens) from the result so as to obtain a more accurate result in the later round of sampling prediction, which is beneficial to improving the image generation effect.

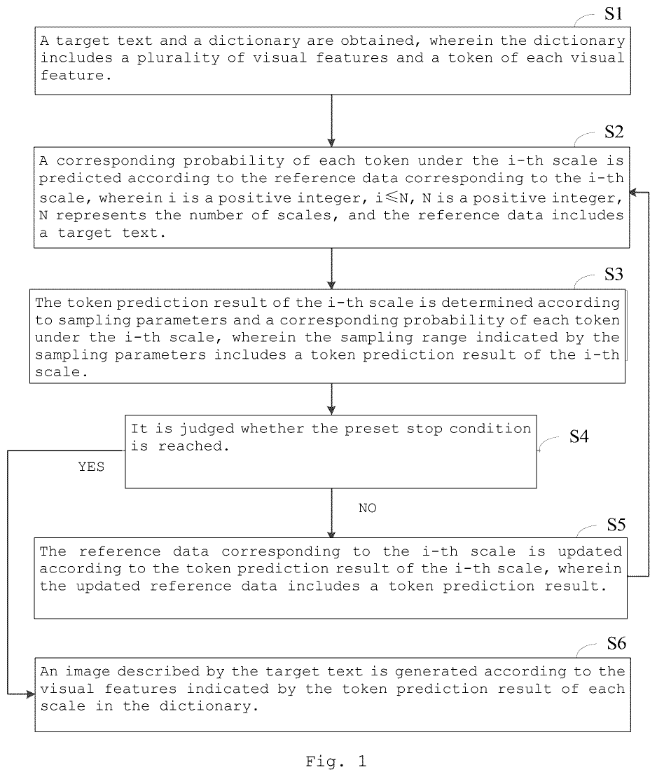

In order to better understand the technical solution provided by the present application, the image generation method provided by the present application will be first explained below in conjunction with some accompanying drawings. As shown in FIG. 1, the image generation method provided by an embodiment of the present application includes S1-S6 below.

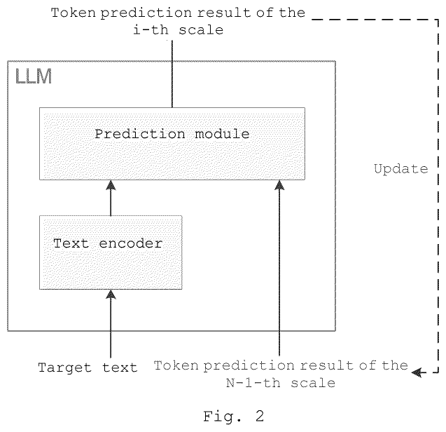

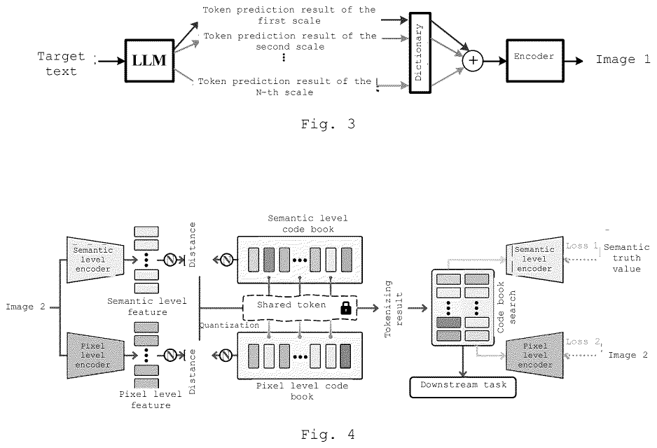

In S1, a target text and a dictionary are obtained, wherein the dictionary includes a plurality of visual features and a token of each visual feature.

Wherein, the target text (as shown in FIG. 2 or FIG. 3) is used to describe what the finally generated image looks like, so that the text may describe the image generation needs of the user. For example, the text may be the character string “A puppy is playing in the grass”.

The dictionary refers to a data set that needs to be used when any data (for example, data such as a text, an image, or an image block) is tokenized, so that the dictionary may provide available data for tokenizing, for example, vocabulary, a discrete feature for representing vocabulary, and a discrete feature for representing image information (for example, semantic level information and/or pixel level information).

It may be seen that, the dictionary may at least include a plurality of visual features and a token of each visual feature, so that the dictionary may describe diverse image information as much as possible. Wherein, the j-th visual feature refers to the discrete feature for describing the j-th image information, identified with the token j, where j is a positive integer, j≤J, J is a positive integer, and J represents the number of visual features in the dictionary.

Further, the present application does not limit the implementation of the j-th visual feature. For example, in some scenes, for example, in the image generation scene realized by the token converter based on pixel reconstruction, the j-th visual feature includes the entries indicated (or identified) by the token j in the code book corresponding to the token converter, so that the j-th visual feature may be used to represent certain pixel level image information.

For another example, in some scenes, for example, in the image generation scene realized by the tokenizing solution shown in FIG. 4, the j-th visual feature may include an entry indicated by the token j in the semantic level code book shown in FIG. 4, and/or an entry indicated by the token j in the pixel level code book shown in FIG. 4. It is to be noted that, the semantic level code book and the pixel level code book at least satisfy the following constraints: the semantic level code book and the pixel level code book share a token therebetween; the semantic level code book includes a plurality of entries, and one entry in this semantic level code book is used to describe image information of a semantic level; the pixel level code book includes a plurality of entries, and one entry in this pixel level code book is used to describe image information of a pixel level, so that the shared token j may jointly represent a plurality of image information (for example, semantic level information and pixel level information).

Further, the present application does not limit the method of obtaining a dictionary. For example, when the image generation method provided in the present application is realized by way of a Large Language Model (LLM), the method of obtaining a dictionary may include: expanding the original glossary in LLM using all the entries in the semantic level code book and all the entries in the pixel level code book to obtain the dictionary, so that the dictionary includes not only the content in the glossary (for example, each word or its discrete feature), but also the content in the two code books (for example, each discrete feature of image information of pixel level and each discrete feature of image information of semantic level), which allows that the dictionary may serve a subsequent process (for example, text feature extraction and decoding process).

In S2, a corresponding probability of each token under the i-th scale is predicted according to the reference data corresponding to the i-th scale, wherein i is a positive integer, i≤N, N is a positive integer, N represents the number of scales, and the reference data includes a target text.

Wherein, the reference data corresponding to the i-th scale refers to the data that needs to be referenced when token prediction processing under the i-th scale is performed, for example, the data that needs to be input when token prediction processing is realized using LLM; and the reference data corresponding to the i-th scale at least includes the target text. It is to be noted that, i is used to represent any scale.

In addition, in order to better improve the image generation effect, the initial value of the reference data corresponding to the i-th scale may at least satisfy the following constraints: when i=1, the initial value of the reference data corresponding to the i-th scale is a target text. However, when i≥2, the initial value of the reference data corresponding to the i-th scale is determined according to the target text and the token prediction result of the i−1th scale.

It may be seen that, in one possible embodiment, when a plurality of scales include a first scale and a second scale, the arrangement position of the first scale among the plurality of scales is adjacent to that of the second scale among the plurality of scales, and the arrangement position of the first scale among the plurality of scales is earlier than that of the second scale among the plurality of scales, the initial value of the reference data corresponding to the second scale is determined according to the target text and the token prediction result of the first scale. Wherein, the second scale is used to represent a scale where arrangement position is not in the first place, and the first scale is used to represent a previous scale corresponding to the scale where the arrangement position is not in the first place.

It is to be noted that, when i≥2, the present application does not limit the process of determining the initial value of the reference data corresponding to the i-th scale (for example, the second scale), for example, it may be as follows: after the token prediction result of the i−1th scale is obtained, up-sampling processing is performed on the visual features indicated by the token prediction result in the dictionary, so as to obtain an up-sampling result, so that the scale of the up-sampling result is consistent with the i-th scale. In this way, the reference data corresponding to the i-th scale can be initialized using the up-sampling result and the target text subsequently, so that the initial value of the reference data corresponding to the i-th scale includes the target text and the up-sampling result, so as to implement overcoming the defect caused by inconsistent scales by adjusting (e.g., resizing) the representation features of the i−1th scale to the i-th scale, which is beneficial to improving the image generation effect.

Based on the content of the above-described two paragraphs, after the target text is obtained, the reference data corresponding to the first scale (for example, 1×1 scale) is initialized according to the text. In this way, multiple rounds of sampling prediction processing for the first scale may be completed based on the initial value of the reference data corresponding to the first scale subsequently, so as to obtain the token prediction result of the first scale, so that the token prediction result may present what information is carried by the image described by the text under the first scale;

Then, the visual features indicated by the token prediction result of the first scale in the dictionary are adjusted to the second scale (for example, 2×2 scale), and the reference data corresponding to the second scale is initialized according to the text and the aforementioned data adjusted to the second scale. In this way, multiple rounds of sampling prediction processing for the second scale may be completed based on the initial value of the reference data corresponding to the second scale subsequently, so as to obtain the token prediction result of the second scale, so that the token prediction result of the second scale may present what information is carried by the image described by the text under the second scale;
. . . (and so forth)

Then, the visual features indicated by the token prediction result of the N−1-th scale in the dictionary are adjusted to the N-th scale (for example, N×N scale), and the reference data corresponding to the N-th scale is initialized according to the text and the aforementioned data adjusted to the N-th scale. In this way, multiple rounds of sampling prediction processing for the N-th scale may be completed based on the initial value of the reference data corresponding to the N-th scale subsequently, so as to obtain the token prediction result of the N-th scale, so that the token prediction result of the N-th scale may present what information is carried by the image described by the text under the N-th scale.

It is to be noted that, N is used to describe the scale of the image described by the target text. For example, if the image is presented using 256×256 tokens (or image blocks), then N is 256. Further, the present application does not limit the method of obtaining N, for example, N may be set according to actual application scenes. For another example, N may be set by the user.

The probability corresponding to the token j at the i-th scale is used to present the possibility that the image described by the target text carries the image information represented by the token j at the i-th scale. Wherein, the image information represented by the token j refers to the image information (for example, semantic level information and/or pixel level information) represented by the visual features indicated (or identified) by the token j in the dictionary, where j is a positive integer and j≤J.

Further, the present application does not limit the implementation of the probability corresponding to the token j at the i-th scale. For example, when the information carried by the image described by the target text at the i-th scale (for example, 1×1 scale) is presented using one token (or one image block), the probability corresponding to the token j at the i-th scale may present the possibility of using the token j as the token. For another example, when the information carried by the image described by the target text at the i-th scale (for example, 2×2 scale) is presented by a token sequence (or a plurality of image blocks), the probability corresponding to the token j at the i-th scale is also presented using a probability sequence, so that each probability in the probability sequence may present the possibility of using the token j as the token of a corresponding position in the token sequence respectively.

Further, the present application does not limit the implementation of S2 described above, for example, S2 may be realized by way of some modules in LLM. For example, when the reference data corresponding to the above-described i-th scale at least includes the target text, S2 may at least include: first, processing the target text by a text encoder in LLM to obtain a token sequence corresponding to the target text, so that each token in the token sequence is used to indicate a corresponding entry in the dictionary respectively, for example, a corresponding entry in the glossary; then, predicting a corresponding probability of each token under the i-th scale by the prediction module in LLM according to the token sequence (and other data, for example, data such as the token prediction result of the i−1th scale), and determining the token prediction result of the i-th scale based on these probabilities.

It is to be noted that, the present application does not limit the implementation of the above-described text encoder, for example, it may be implemented by Byte Pair Encoding (BPE). Further, the present application does not limit the implementation of the above-described prediction module, for example, it may be implemented using Transformer.

In S3, the token prediction result of the i-th scale is determined according to sampling parameters and a corresponding probability of each token under the i-th scale, wherein the sampling range indicated by the sampling parameters includes a token prediction result of the i-th scale.

Wherein, the sampling parameters are used to limit the sampling range under the top-k top-p sampling strategy. Moreover, the sampling parameters include a first parameter (k parameter) and a second parameter (p parameter). Wherein, the first parameter is used to constrain the sampling range of the top-k sampling strategy. For example, if the first parameter is 3, the top-k sampling strategy is used to sample the top three candidates. The second parameter is used to constrain the sampling range of the top-p sampling strategy. For example, if the second parameter is 0.8, the top-p sampling strategy is used to sample multiple candidates with the highest ranking, whose probability sum reaches 0.8.

In addition, the sampling parameters may be preset.

The token prediction result of the i-th scale is used to represent the image information carried by the image described by the target text under the i-th scale.

In addition, the present application does not limit the implementation of the token prediction result of the i-th scale. For example, when the information carried by the image described by the target text under the i-th scale (for example, 1×1 scale) is presented using one token, the token prediction result of the i-th scale includes one token. For another example, when the information carried by the image described by the target text under the i-th scale (for example, 2×2 scale) is presented using a token sequence, the token prediction result of the i-th scale is a token sequence (for example, 2×2 sequence).

Further, the present application does not limit the implementation of S3 described above, for example, it may specifically include: first, sampling at least one token from the tokens of the above-described plurality of visual features according to sampling parameters and a corresponding probability of each token under the i-th scale, so that the at least one token may present the sampling range indicated by the sampling parameters; then, obtaining the token prediction result of the i-th scale by randomly selecting the at least one token.

It may be seen that, when the information carried by the image described by the target text at the i-th scale (for example, 2×2 scale) is presented using a token sequence, the probability corresponding to the token j at the i-th scale is a probability sequence, and the dimension of the probability sequence is the same as that of the token sequence, where j is a positive integer, and j &J, first, according to sampling parameters and the q-th data in the probability sequence corresponding to each token at the i-th scale, at least one token is sampled from the tokens of the above-described plurality of visual features as a sampling result corresponding to the q-th data in the token sequence, and randomly selecting a token from the sampling result corresponding to the q-th data in the token sequence as a matched token of the q-th data in the token sequence, where q is a positive integer, q≤Q, Q is a positive integer, and Q represents the dimension of the token sequence; then, according to the matched tokens of the data in the token sequence, the token prediction result of the i-th scale is determined, so that the token prediction result includes these matched tokens.

Also, the above-described S3 may also be realized by the prediction module in LLM.

In S4, it is judged whether the preset stop condition is reached. If YES, the following S6 is performed. If NO, the following S5 is performed.

Wherein, the preset stop condition refers to the condition that needs to be reached when multiple rounds of sampling prediction under the same scale are stopped, for example, the number of rounds of performing sampling prediction for the i-th scale reaches a preset threshold of rounds (for example, 3 rounds).

It is to be noted that, the present application does not limit the timing of judging the preset stop condition, which may be performed before or after the following update.

In S5, the reference data corresponding to the i-th scale is updated according to the token prediction result of the i-th scale, wherein the updated reference data includes a token prediction result, and return to continue to perform the above S2 and its subsequent steps.

It is to be noted that, the present application does not limit the implementation of S5 described above. For example, if the current round is the first round of sampling processing for the i-th scale, it may be determined that the reference data corresponding to the i-th scale is not present with the token prediction result of the i-th scale, so that the token prediction result of the i-th scale determined in the current round may be directly added to the reference data corresponding to the i-th scale. However, if the current round is not the first round of sampling processing for the i-th scale, it may be determined that the reference data corresponding to the i-th scale includes a token prediction result of the i-th scale obtained through a previous round of sampling prediction processing, so that the token prediction result of the i-th scale determined in the current round may directly replace the existing token prediction result in the reference data corresponding to the i-th scale. In this way, it is possible to implement that the latter round of sampling prediction is realized on the basis of the result obtained from the previous round of sampling prediction among multiple rounds of sampling prediction of the same scale, which is beneficial to improving the image generation effect.

In S6, an image described by the target text is generated according to the visual features indicated by the token prediction result of each scale in the dictionary.

It is to be noted that, the present application does not limit the implementation of S6. For example, as shown in FIG. 3, S6 may specifically include: after the token prediction results of all scales are obtained, the visual features indicated by the token prediction results of all scales in the dictionary may be first added (or spliced) to obtain a processing result; and the decoder then decodes the processing result to obtain an image described by the target text (for example, the image 1 shown in FIG. 3), so that the image may satisfy the image generation requirements described by the text.

Further, the present application does not limit the implementation of the decoder, and only needs to ensure that the decoder is matched with a plurality of visual features in the dictionary. For example, when each visual feature in the dictionary is used to represent the image information of pixel level, the decoder may be implemented using any decoder that may decode a discrete feature of pixel level (for example, the decoder in the image generation realized by the token converter based on pixel reconstruction). Also for example, when each visual feature in the dictionary is used to represent image information of semantic level, the decoder may be implemented using any decoder that may decode a discrete feature of semantic level (the decoder in the image generation realized by the token converter based on semantic). For another example, when each visual feature in the dictionary is used to jointly represent semantic level information and pixel level information, the decoder may be implemented using the pixel level decoder shown in FIG. 4.

Further, in order to better improve the image generation effect, multiple visual features in the dictionary and the decoder may be determined using the same training process (the training process as shown in FIG. 4), so as to make both of them more coordinated.

Also, the present application does not limit the implementation of the training process described in the previous paragraph, for example, it may be implemented in the following steps I to IV.

In Step I, a sample image (such as the image 2 shown in FIG. 4) is obtained, and the sample image is divided into a plurality of image blocks;

In Step II, the semantic level feature of each image block is determined using a semantic level encoder, and the pixel level feature of each image block is determined using a pixel level encoder;

In Step III, for any image block, the matched token of the image block is determined according to the distance between the semantic level feature of the image block and each entry in the semantic level code book, and the distance between the pixel level feature of the image block and each entry in the pixel level code book, so as to ensure that the sum of the distance obtained by adding the distance between the entry indicated by the matched token in the semantic level code book and the semantic level feature and the distance between the entry indicated by the matched token in the pixel level code book and the pixel level feature reaches a minimum value, so that the semantic decoder may process the entry indicated by the matched token in the semantic level code book to obtain a semantic prediction result and the pixel decoder may process the entry indicated by the matched token in the pixel level code book to obtain a pixel prediction result (for example, reconstructing an image) subsequently.

In Step IV, based on the difference between the semantic prediction result and its corresponding semantic true value (the loss 1 as shown in FIG. 4), the difference between the pixel prediction result and the sample image (the loss 2 as shown in FIG. 4), the difference between the semantic level feature and the entry indicated by the matched token in the semantic level code book, and the difference between the pixel level feature and the entry indicated by the matched token in the pixel level code book, update the parameters in the two encoders, the entries in the two code books and the parameters in the two decoders, and return to continue to perform the above-described Step I and its subsequent steps, for iterative loop as such, until a preset training stop condition (for example, a condition that the loss is lower than the preset loss threshold, the change rate of the loss is lower than the preset change rate threshold, or the updating times reaches the preset times threshold) is reached. Wherein, the loss is determined according to the difference between the semantic prediction result and its semantic true value (for example, the L2 distance), the difference between the pixel prediction result and the sample image (for example, the pixel reconstruction loss, the perception loss and the adversarial loss), the difference between the semantic level feature and the entry indicated by the matched token in the semantic level code book (for example, the code book learning loss), and the difference between the pixel level feature and the entry indicated by the matched token in the pixel level code book (for example, the code book learning loss). The present application does not limit the calculation process of the loss.

It is to be noted that, for the semantic true value corresponding to the semantic prediction result of any image block, the true value is obtained by performing semantic feature extraction on the image block by the teacher model of the semantic level encoder. Wherein, the semantic level encoder is initialized using the teacher model. Further, the present application does not limit the above-described implementation of the code book learning loss, for example, it may be implemented by the following formula (1).

$${ℒ}_{VQ} = {‖ sg [ \hat{z} ] - z ‖}_{2}^{2} + β {‖ \hat{z} - sg [ z ] ‖}_{2}^{2} \qquad ( 1 )$$

In the formula, [symbol] _{VQ} represents the code book learning loss; \hat{z} represents the original feature (for example, the semantic level feature or the pixel level feature of an image block); z represents the discrete feature closest to the original feature searched from the code book (for example, the entry indicated by the matched token of the image block in the semantic level code book or the entry indicated by the matched token in the pixel level code book); sg [·] represents stop-gradient operation.

On the basis of the relevant content of the above S1 to S6, the image generation method provided by the present application includes a process of predicting a token sequence under a plurality of scales, and the process of predicting a token sequence under each scale is obtained through multiple rounds of sampling prediction, so as to realize a later round of sampling prediction on the basis of a result obtained from an earlier round of sampling prediction under the same scale so that the later round of sampling prediction may acquire an associated relationship between different local areas represented by different tokens from the result so as to obtain a more accurate result in the later round of sampling prediction, which is beneficial to improving the image generation effect.

Further, the present application does not limit the performing subject of the image generation method, for example, the method may be applied to a terminal device or a server. For another example, the method may also be realized by the data interaction process between the terminal device and the server. Wherein, the terminal device may be a smart phone, a computer, a Personal Digital Assistant (PDA), a tablet computer, etc. The server may be a dedicated server, a cluster server or a cloud server.

It has been found through studies that, it is possible to achieve a better image generation effect by multiple rounds of sampling prediction realized by gradually narrowing the sampling range.

Based on the above-described studies, the present application also provides an implementation of the token prediction process of the i-th scale, which may include the following steps 21 to 24.

In Step 21, the initial value of the reference data corresponding to the i-th scale is obtained. If i=1, the initial value is determined according to the target text; if i≥2, the initial value is determined according to the target text and the token prediction result of the i−1th scale.

In Step 22, a corresponding probability of each token under the i-th scale is predicted according to the reference data corresponding to the i-th scale, where i is a positive integer.

It is to be noted that, for the relevant content of Step 22, please refer to the relevant content of the above S2.

In Step 23, the token prediction result of the i-th scale is determined according to sampling parameters and a corresponding probability of each token under the i-th scale, and the sampling range indicated by the sampling parameters includes a token prediction result of the i-th scale.

It is to be noted that, for the relevant content of step 23, please refer to the relevant content of the above S3.

It is also to be noted that, the initial values of the sampling parameters at the i-th scale are preset. In addition, the corresponding initial values of the sampling parameters at different scales may be the same or different, which is not specifically limited in the present application.

In Step 24, according to the token prediction result of the i-th scale, update the reference data corresponding to the i-th scale so that the updated reference data includes a token prediction result, update the sampling parameters so that the sampling range indicated by the updated sampling parameters is smaller than that indicated by the sampling parameters before updating, and continue to perform the above-described Step 22 and its subsequent steps until the preset stop condition is reached.

It is to be noted that, the present application does not limit the method of updating the sampling parameters. For example, when the sampling parameters before updating include k1 and p1, and the updated sampling parameters include k2 and p2, the updating method may satisfy the following constraints: k2<k1 and p2<p1.

It is also to be noted that, the present application does not limit the implementation of the preset stop condition in Step 24 described above. For example, the preset stop condition may include that the sampling range indicated by the sampling parameters before updating is not greater than the preset range threshold (for example, the sampling parameters for indicating that only one candidate is sampled), which is beneficial to improving the flexibility of multiple rounds of sampling prediction.

For another example, the above-described preset stop condition may include that: the updating times of the reference data corresponding to the i-th scale reach a preset times threshold (for example, twice), which is beneficial to improving the efficiency of multiple rounds of sampling prediction.

Based on the relevant content of the above-described steps 21 to 24, it may be known that, for multiple rounds of sampling prediction under the same scale, the latter round of sampling prediction is realized based on the result obtained from the previous round of sampling prediction, and the sampling range involved in this latter round of sampling prediction is smaller than that involved in the previous round of sampling prediction, so that it is possible to ensure the local consistency of the image as much as possible by gradually narrowing the sampling range, which is beneficial to improving the image generation effect.

It has been found through studies that, multiple rounds of sampling prediction are used to overcome the defects caused by independent prediction processes of different tokens in the token sequence. Therefore, in order to improve the reasoning speed as much as possible, the i-th scale adapted to perform token prediction processing by way of multiple rounds of sampling prediction satisfies the following constraints: the i-th scale is greater than the preset scale threshold (for example, 1×1 scale), and/or the i-th scale token prediction result includes at least two tokens.

It may be seen that, in one possible embodiment, for any scale of a plurality of scales, the token prediction process of the scale includes: first, predicting a corresponding probability of each token under the scale according to the reference data corresponding to the scale; then, determining the token prediction result of the scale according to sampling parameters and a corresponding probability of each token under the scale, so as to update the reference data corresponding to the scale according to the token prediction result of the scale, so that the updated reference data includes the token prediction result, and continue to perform the aforementioned step of “predicting a corresponding probability of each token under the scale according to the reference data corresponding to the scale” and its subsequent steps until the preset stop condition is reached when it is determined that the scale is greater than a predetermined scale threshold, and/or the token prediction result of the scale includes at least two tokens.

Based on this, it may be known that, in some scenes, after the target text is obtained, the token prediction result at the 1×1 scale is first determined according to the target text, so that the token prediction process at the 1×1 scale only includes one round of sampling prediction; and the token prediction result at the m-th scale is then determined according to the target text and the token prediction result at the m−1th scale (for example, the 2×2 scale), so that the token prediction result at the m-th scale includes at least two rounds of sampling prediction, where m is a positive integer, m≥2 and m≤N; then, the image described by the target text is generated according to the visual features indicated by the token prediction result of each scale in the dictionary, which is beneficial to improving the efficiency.

In addition, in order to better improve the image generation effect, the present application also provides a training process of the above-described LLM model, which specifically includes the following Steps 31 to 34.

In Step 31, a data pair constructed in advance is obtained, wherein the data pair includes a text and an image, and the text is used to describe the image.

It is to be noted that, the present application does not limit the implementation of Step 31.

In Step 32, the image in the above data pair is tokenized to obtain a tokenizing result (for example, a token sequence) of each scale.

It is to be noted that, the present application does not limit the implementation of Step 32, for example, it may be implemented by way of the tokenization process shown in FIG. 4. Wherein, the symbol “N” in FIG. 4 is used to indicate normalization processing.

It may be seen that, in one possible embodiment, after the image in the data pair is obtained, the above-described Step 32 may specifically include the following process:
First, the semantic level feature of the image (for example, the semantic level feature of each image block) is obtained using a semantic level encoder, and the pixel level feature of the image (for example, the pixel level feature of each image block) is obtained using a pixel level encoder;
Then, down-sampling is performed on the semantic level feature of the image to obtain the semantic level feature at the first scale (for example, the 1×1 scale), so that the information described by the semantic level feature at the first scale is equivalent to that described by the 1×1 image block, and down-sampling is performed on the pixel level feature of the image to obtain the pixel level feature at the first scale, so that the information described by the pixel level feature at the first scale is equivalent to that described by the 1×1 image block;
Then, the tokenizing result of the first scale is determined according to the distance between the semantic level feature at the first scale and each entry in the semantic level code book and the distance between the pixel level feature at the first scale and each entry in the pixel level code book, so that the tokenizing result may present the image information actually carried by the image at the first scale;
Then, the difference feature sem1 between the entry indicated by the tokenizing result of the first scale in the semantic level code book and the semantic level feature of the image is calculated, so that the difference feature sem1 may present the difference between the semantic level information indicated by the tokenizing result and the semantic level information carried by the image, and the difference feature pix1 between the entry indicated by the tokenizing result of the first scale in the pixel level code book and the pixel level feature of the image is calculated, so that the difference feature pix1 may present the difference between the pixel level information indicated by the tokenizing result and the pixel level information carried by the image;
Then, down-sampling is performed on the difference feature sem1 to obtain the semantic level feature at the second scale (for example, the 2×2 scale), so that the information described by the semantic level feature at the second scale is equivalent to that described by the 2×2 image block, and down-sampling is performed on the difference feature sem1 to obtain the pixel level feature at the second scale, so that the information described by the pixel level feature at the second scale is equivalent to that described by the 2×2 image block;
Then, the tokenizing result of the second scale is determined according to the distance between the semantic level feature at the second scale and each entry in the semantic level code book and the distance between the pixel level feature at the second scale and each entry in the pixel level code book, so that the tokenizing result may present the image information actually carried by the image at the second scale;
Then, the difference feature sem2 between the entry indicated by the tokenizing result of the second scale in the semantic level code book and the difference feature sem1 is calculated, so that the difference feature sem2 may present the difference between the semantic level information indicated by the tokenizing result and the semantic level information carried by the difference feature sem1, and the difference feature sem2 between the entry indicated by the tokenizing result of the first scale in the pixel level code book and the pixel level feature of the image is calculated, so that the difference feature sem2 may present the difference between the pixel level information indicated by the tokenizing result and the pixel level information carried by the difference feature sem1; . . . (and so forth), until the tokenizing result of the N-th scale is determined. Then, it is over.

It is to be noted that, in order to better unify the feature space, after the tokenizing result of each scale shown in the above-described process is obtained, it may be processed by a two-layer Multilayer Perceptron (MLP) to avoid the defect caused by non-uniform feature space, which is beneficial to improving the effect.

It is also to be noted that, the present application does not limit the performing time of Step 32, and only needs to ensure that the performing time of Step 32 is earlier than that of Step 34 below.

It is still to be noted that, the present application does not limit the use of the tokenizing result of each scale, for example, it may be first spliced with the token sequence of the text in the above-described data pair; the stitching result may be then input to LLM, so that LLM may obtain the token sequence from the stitching result to perform token prediction processing, and obtain the tokenizing results of these scales from the stitching result to guide the token prediction processing.

In Step 33, the text in the above-described data pair is input into LLM to obtain the token prediction result of each scale where LLM is situated.

It is to be noted that, the implementation of the above-described Step 32 is similar to the processing process of the above target text, which will not be described in detail for the sake of conciseness.

In Step 34, update LLM according to the difference between the token prediction result of each scale and the tokenizing result of each scale, and return to continue to perform Step 31 and its subsequent steps until the preset iteration stop condition (for example, the model loss is lower than the preset loss threshold, the change rate of model loss is lower than the preset change rate threshold, or the updating times of LLM reaches the preset number of times threshold) is reached, and then end the iterative training process for LLM.

It is to be noted that, the model loss shown in the previous paragraph is used to represent the performance of LLM, and the loss is determined according to the difference (for example, cross entropy loss) between the token prediction result of each scale and the tokenizing result of each scale, and the present application does not limit the calculation method of the loss.

Based on the relevant content of Steps 31 to 34 above, it may be known that, in some scenes, LLM is trained using a text-image pair, so that the trained LLM (LLM as shown in FIG. 2 or 3) may realize high-quality image generation in the next-scale prediction paradigm, so that LLM presents a favorable text-to-image performance.

In addition, during the training process of LLM, the conditional text is randomly replaced by an empty string with a probability of 0.1 to support Classifier-Free Guidance (CFG) reasoning.

In addition, QK-normalization mechanism and norm re-ordering are introduced in the LLM training process to stabilize the training process so as to improve the stability of model training.

Based on the relevant content of the above-described image processing method, it may be known that, the image generation solution based on the next-scale prediction paradigm provided by the present application has the advantages shown in the following \textcircled{1} to \textcircled{4}.
\textcircled{1} Compared with some image generation solutions based on an encoder-decoder architecture (for example, a diffusion model), the decoder-only architecture used in the present application is more likely to be combined with LLM.
\textcircled{2} The present application realizes the image generation process from coarse to fine (that is, the image generation process from fuzzy to clear) by way of a gradual generation method of the next-scale prediction paradigm, which significantly reduces the computational complexity, so as to achieve a fast reasoning speed.
\textcircled{3} The multi-stage sampling prediction solution provided in the present application effectively solves the problems such as image collapse and repetitive pattern, and improves the visual quality and diversity of the generated image.
\textcircled{4} The overall solution of the present application reduces the demand for computational resources whilst maintaining the high-quality image generation capability, and improves the practicability of the solution.

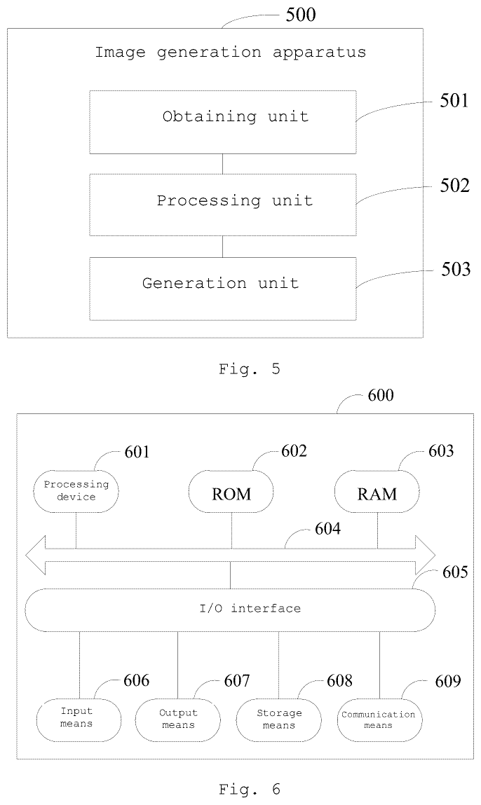

Based on the image generation method provided by the embodiment of the present application, the embodiment of the present application also provides an image generation apparatus, which will be interpreted and explained below in conjunction with FIG. 5. Wherein, FIG. 5 is a schematic structural view of an image generation apparatus provided by an embodiment of the present application. It is to be noted that, for the technical details of the image generation apparatus provided by the embodiment of the present application, please refer to the relevant content of the image generation method above.

As shown in FIG. 5, the image generation apparatus 500 provided by the embodiment of the present application comprises:

An obtaining unit 501 configured to obtain a target text and a dictionary, wherein the dictionary includes a plurality of visual features and a token of each visual feature;

A processing unit 502 configured to predict a corresponding probability of each token under the scale according to the reference data corresponding to the scale for each of the plurality of scales, wherein the reference data includes the target text; determining a token prediction result of the scale according to sampling parameters and a corresponding probability of each token under the scale, wherein the sampling range indicated by the sampling parameters includes a token prediction result of the scale; updating the reference data corresponding to the scale according to the token prediction result of the scale, wherein the updated reference data includes the token prediction result, and continuing to perform the step of predicting a corresponding probability of each token under the scale according to the reference data corresponding to the scale until a preset stop condition is reached;

A generation unit 503 configured to generate an image described by the target text according to the visual features indicated by the token prediction results of the plurality of scales in the dictionary.

In one possible embodiment, the processing unit 502 is specifically configured to: update the reference data corresponding to the scale according to the token prediction result of the scale, wherein the updated reference data includes the token prediction result; update the sampling parameters, wherein the sampling range indicated by the updated sampling parameters is smaller than that indicated by the sampling parameters before updating; and continue to perform the step of predicting a corresponding probability of each token under the scale according to the reference data corresponding to the scale.

In one possible implementation, the preset stop condition includes that: the sampling range indicated by the sampling parameters before updating is not greater than the preset range threshold.

In one possible embodiment, the preset stop condition includes that: the updating times of the reference data corresponding to the scale reach a preset times threshold.

In one possible embodiment, the processing unit 502 is specifically configured to: update, for any scale of a plurality of scales, the reference data corresponding to the scale according to the token prediction result of the scale if that scale is greater than a preset scale threshold, and/or the token prediction result of the scale includes at least two tokens.

In one possible embodiment, the plurality of scales include a first scale and a second scale, the arrangement position of the first scale among the plurality of scales is adjacent to that of the second scale among the plurality of scales, and the arrangement position of the first scale among the plurality of scales is earlier than that of the second scale among the plurality of scales; and the initial value of the reference data corresponding to the second scale is determined according to the target text and the token prediction result of the first scale.

In one possible embodiment, the image is generated using a decoder; the decoder and the plurality of visual features are determined using the same training process.

Based on the relevant content of the above-described image generation apparatus 500, it may be known that, the operation principles of the apparatus 500 include: performing a process of predicting a token sequence under a plurality of scales, and the process of predicting a token sequence under each scale is obtained through multiple rounds of sampling prediction, so as to realize a later round of sampling prediction on the basis of a result obtained from an earlier round of sampling prediction under the same scale so that the later round of sampling prediction may acquire an associated relationship between different local areas represented by different tokens from the result so as to obtain a more accurate result in the later round of sampling prediction, which is conducive to improving the image generation effect.

In addition, the embodiment of the present application also provides an electronic device. The electronic device comprises: a processor and a memory; wherein the memory is used to store instructions or computer programs; and the processor is used to execute the instructions or computer programs in the memory, so as to cause the electronic device to perform any embodiment of the image generation method provided by the embodiment of the present application.

Referring to FIG. 6, it shows a schematic structural view of an electronic device 600 suitable for implementing the embodiment of the present disclosure. The terminal device in the embodiment of the present disclosure may include, but is not limited to, a mobile terminal such as a mobile phone, a notebook computer, a digital broadcast receiver, PDA (Personal Digital Assistant), PAD (Pad Computer), PMP (Portable Multimedia Player) and a vehicle-mounted terminal (for example, a vehicle-mounted navigation terminal); and a fixed terminal such as digital TV and a desktop computer. The electronic device shown in FIG. 6 is only an example and shall not limit the functions and application range of the embodiments of the present disclosure.

As shown in FIG. 6, the electronic device 600 may include a processing device (for example, a central processing unit, a graphic processor, and the like) 601, which may perform various suitable actions and processing according to a program stored in a Read-only Memory (ROM) 602 or a program loaded from a storage device 608 into a Random Access Memory (RAM) 603. In the RAM 603, various programs and data required for the operation of the electronic device 600 are also stored. The processing device 601, the ROM 602 and the RAM 603 are connected to each other through a bus 604. The input/output (I/O) interface 605 is also connected to the bus 604.

Generally, the following devices may be connected to the I/O interface 605: an input means 606 including, for example, a touch screen, a touch pad, a keyboard, a mouse, a camera, a microphone, an accelerometer, a gyroscope, and the like; an output means 607 including, for example, a Liquid Crystal Display (LCD), a speaker, a vibrator, and the like; a storage means 608 including, for example, a magnetic tape, a hard disk, and the like; and a communication means 609. The communication means 609 may allow the electronic means 600 to be in wireless or wired communication with other devices to exchange data. Although FIG. 6 shows the electronic device 600 with various devices, it should be understood that it is not required to implement or possess all the devices shown. It is possible to alternatively implement or possess more or less devices.

In particular, according to the embodiment of the present disclosure, the process described above with reference to the flowchart may be implemented as a computer software program. For example, an embodiment of the present disclosure includes a computer program product, which includes a computer program carried on a non-transient computer-readable medium, wherein the computer program contains program codes for performing the method shown in the flowchart. In such embodiment, the computer program may be downloaded and installed from the network through the communication means 609, installed from the storage means 608, or installed from the ROM 602. When the computer program is executed by the processing device 601, the above-described functions defined in the method of the embodiment of the present disclosure are performed.

The electronic device provided by the embodiment of the present disclosure pertains to the same inventive concept as the method provided by the above-described embodiments, and reference may be made to the above-described embodiments for the technical details that have not been elaborated, and this embodiment has the same beneficial effects as the above-described embodiments.

The present application also provides a computer-readable medium. The computer-readable medium has instructions or computer programs stored thereon that, when running on a device, cause the device to perform any embodiment of the image generation apparatus provided by the embodiment of the present application.

It is to be noted that, the above-described computer-readable medium of the present disclosure may be a computer-readable signal medium, a computer-readable storage medium or any combination thereof. The computer-readable storage medium may be, for example, but is not limited to: an electrical, magnetic, optical, electromagnetic, infrared, or semiconductor system, device, or apparatus, or a combination thereof. More specific examples of the computer-readable storage medium may include, but is not limited to: an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that contains or stores a program which may be used by an instruction execution system, apparatus, or device or used in combination therewith. In the present disclosure, the computer-readable signal medium may include a data signal propagated in a baseband or as a part of a carrier wave, wherein a computer-readable program code is carried. This propagated data signal may use multiple forms, including but not limited to electromagnetic signals, optical signals or any suitable combination thereof. The computer-readable signal medium may also be any computer-readable medium other than a computer-readable storage medium, which may send, propagate or transmit a program for use by or in connection with an instruction execution system, apparatus or device. The program code contained on the computer-readable medium may be transmitted by any suitable medium, including but not limited to: a wire, an optical cable, radio frequency (RF), and the like, or any suitable combination thereof.

In some embodiments, the client and the server may communicate using any currently known or future developed network protocol such as HTTP (Hyper Text Transfer Protocol), and may be interconnected with digital data communication in any form or medium (for example, communication network). Examples of communication networks include a Local Area Network (“LAN”), a Wide Area Network (“WAN”), an extranet (for example, Internet) and an end-to-end network (for example, an ad hoc end-to-end network), as well as any currently known or future developed network.

The above-described computer-readable medium may be included in the above-described electronic device; or may also exist alone without being assembled into the electronic device.

The above-described computer-readable medium carries one or more programs that, when executed by the electronic device, cause the electronic device to perform the above-described method.

The computer program code for performing the operations of the present disclosure may be written in one or more programming languages or a combination thereof. The above-described programming languages include but are not limited to object-oriented programming languages, such as Java, Smalltalk, and C++, and also include conventional procedural programming languages, such as “C” language or similar programming languages. The program code may be executed entirely on the user computer, partly on the user computer, executed as an independent software package, partly on the user computer and partly executed on a remote computer, or entirely executed on the remote computer or server. In the case of a remote computer, the remote computer may be connected to the user computer through any kind of network (including a local area network (LAN) or a wide area network (WAN)), or may be connected to an external computer (for example, connected through Internet using an Internet service provider).

The flowcharts and block diagrams in the accompanying drawings illustrate the possibly implemented architectures, functions, and operations of the system, method, and computer program product according to various embodiments of the present disclosure. In this regard, each block in the flowchart or block diagram may represent a module, a program segment, or a part of code, wherein the module, the program segment, or the part of code contains one or more executable instructions for realizing a specified logic function. It should also be noted that, in some implementations as an alternative, the functions marked in the block may also occur in a sequence different from that marked in the accompanying drawings. For example, two blocks shown in succession which may actually be executed substantially in parallel, may sometimes also be executed in a reverse order, depending on the functions involved. It is also to be noted that, each block in the block diagram and/or flowchart, and a combination of blocks in the block diagram and/or flowchart, may be implemented by a dedicated hardware-based system that performs specified functions or operations, or may be implemented by a combination of dedicated hardware and computer instructions.

The units involved in the described embodiments of the present disclosure may be implemented in software or hardware. Wherein, the names of the units/modules do not constitute a limitation on the units themselves under a certain circumstance.

The functions described above herein may be performed at least in part by one or more hardware logic components. For example, non-restrictively, the hardware logic components of a demonstrative type that may be used include: a Field Programmable Gate Array (FPGA), an Application Specific Integrated Circuit (ASIC), an Application Specific Standard Product (ASSP), a System on Chip (SOC), a Complex Programmable Logical device (CPLD) and the like.

In the context of the present disclosure, the machine-readable medium may be a tangible medium that may contain or store a program for use by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination thereof.

It is to be noted that, various embodiments in this specification is described in a progressive way, and each embodiment focuses on the differences from other embodiments, so the same and similar parts among each embodiment can be referred to each other. As for the system or device disclosed in the embodiment, since it corresponds to the method disclosed in the embodiment, the description is relatively simple, so that the related parts can be referred to the description of the method part.

It should be understood that, in the present application, “at least one (item)” means one or more, and “a plurality of” means two or more. “and/or” is used to describe an associated relationship between associated objects, indicating that there may be three relationships. For example, “A and/or B” may present that there are three circumstances of only A, only B and A and B at the same time, where A and B may be singular or plural. The character “/” generally presents that the contextually associated objects are in an “or” relationship. “At least one of the following (items)” or its similar expression refers to any combination of these items, including any combination of single (item) or plural (items). For example, at least one (item) of a, b or c may present: a, b, c, “a and b”, “a and c”, “b and c”, or “a and b and c”, where a, b and c may be single or multiple.

It is also to be noted that, the relational terms such as “first” and “second” herein are only used to distinguish one entity or operation from another entity or operation, but do not necessarily require or imply that there is any such actual relationship or order between these entities or operations. Moreover, the terms “comprising”, “including” or any other variation thereof are intended to cover non-exclusive inclusions, so that a process, method, article or device including a series of elements includes not only those elements, but also other elements not explicitly listed or elements inherent to such process, method, article or device. Without further restrictions, an element defined by the phrase “including one . . . ” does not exclude the existence of other identical elements in the process, method, article or device including the element.

The steps of a method or algorithm described in conjunction with the embodiments disclosed herein may be directly implemented in hardware, a software module executed by a processor, or a combination thereof. The software module may be placed in a random access memory (RAM), an internal memory, a read-only memory (ROM), an electrically programmable ROM, an electrically erasable programmable ROM, a register, a hard disk, a removable disk, CD-ROM, or any other form of storage medium known in the technical field.

The above-described description of the disclosed embodiments enables those skilled in the art to realize or use the present application. Multiple modifications to these embodiments will be obvious for those skilled in the art, and the general principles defined herein may be realized in other embodiments without departing from the spirit or scope of the present application. Therefore, the present application will not be limited to these embodiments shown herein, but intended to conform to the broadest scope consistent with the principles and novel features disclosed herein.

What is claimed is:

1. An image generation method, comprising:
obtaining a target text and a dictionary, wherein the dictionary comprises a plurality of visual features and a token of each visual feature;
for any scale of a plurality of scales, predicting a corresponding probability of each token under the scale according to reference data corresponding to the scale, wherein the reference data comprises the target text;
determining a token prediction result of the scale according to sampling parameters and the corresponding probability of each token under the scale, wherein the sampling range indicated by the sampling parameters comprises a token prediction result of the scale;
updating the reference data corresponding to the scale according to the token prediction result of the scale, wherein the updated reference data comprises the token prediction result, and continuing to perform the step of predicting the corresponding probability of each token under the scale according to the reference data corresponding to the scale until a preset stop condition is reached; and
generating an image described by the target text according to the visual features indicated in the dictionary by the token prediction results of the plurality of scales.

2. The method according to claim 1, wherein after the determining the token prediction result of the scale, the method further comprises:
updating the sampling parameters, wherein the sampling range indicated by the updated sampling parameters is smaller than that indicated by the sampling parameters before updating.

3. The method according to claim 2, wherein the preset stop condition comprises that: the sampling range indicated by the sampling parameters before updating is not greater than a preset range threshold.

4. The method according to claim 1, wherein the preset stop condition comprises that: the updating times of the reference data corresponding to the scale reach a preset times threshold.

5. The method according to claim 1, wherein the updating the reference data corresponding to the scale according to the token prediction result of the scale comprises:
for any scale of a plurality of scales, if the scale is greater than a preset scale threshold, and/or the token prediction result of the scale comprises at least two tokens, the reference data corresponding to the scale is updated according to the token prediction result of the scale.

6. The method according to claim 1, wherein the plurality of scales comprise a first scale and a second scale, the arrangement position of the first scale among the plurality of scales is adjacent to that of the second scale among the plurality of scales, and the arrangement position of the first scale among the plurality of scales is earlier than that of the second scale among the plurality of scales; and
the initial value of the reference data corresponding to the second scale is determined according to the target text and the token prediction result of the first scale.

7. The method according to claim 1, wherein the image is generated using a decoder;
the decoder and the plurality of visual features are determined using the same training process.

8. An electronic device, comprising: a processor and a memory;
the memory is used to store instructions or computer programs; and
the processor is used to execute the instructions or computer programs in the memory, so as to cause the electronic device to perform an image generation method comprising:
obtaining a target text and a dictionary, wherein the dictionary comprises a plurality of visual features and a token of each visual feature;
for any scale of a plurality of scales, predicting a corresponding probability of each token under the scale according to reference data corresponding to the scale, wherein the reference data comprises the target text;
determining a token prediction result of the scale according to sampling parameters and the corresponding probability of each token under the scale, wherein the sampling range indicated by the sampling parameters comprises a token prediction result of the scale;
updating the reference data corresponding to the scale according to the token prediction result of the scale, wherein the updated reference data comprises the token prediction result, and continuing to perform the step of predicting the corresponding probability of each token under the scale according to the reference data corresponding to the scale until a preset stop condition is reached; and
generating an image described by the target text according to the visual features indicated in the dictionary by the token prediction results of the plurality of scales.

9. The electronic device according to claim 8, wherein after the determining the token prediction result of the scale, the method further comprises:
updating the sampling parameters, wherein the sampling range indicated by the updated sampling parameters is smaller than that indicated by the sampling parameters before updating.

10. The electronic device according to claim 9, wherein the preset stop condition comprises that: the sampling range indicated by the sampling parameters before updating is not greater than a preset range threshold.

11. The electronic device according to claim 8, wherein the preset stop condition comprises that: the updating times of the reference data corresponding to the scale reach a preset times threshold.

12. The electronic device according to claim 8, wherein the updating the reference data corresponding to the scale according to the token prediction result of the scale comprises:
for any scale of a plurality of scales, if the scale is greater than a preset scale threshold, and/or the token prediction result of the scale comprises at least two tokens, the reference data corresponding to the scale is updated according to the token prediction result of the scale.

13. The electronic device according to claim 8, wherein the plurality of scales comprise a first scale and a second scale, the arrangement position of the first scale among the plurality of scales is adjacent to that of the second scale among the plurality of scales, and the arrangement position of the first scale among the plurality of scales is earlier than that of the second scale among the plurality of scales; and
the initial value of the reference data corresponding to the second scale is determined according to the target text and the token prediction result of the first scale.

14. A non-transitory computer-readable medium, having instructions or computer programs stored thereon that, when run on a device, cause the device to perform an image generation method comprising:
obtaining a target text and a dictionary, wherein the dictionary comprises a plurality of visual features and a token of each visual feature;
for any scale of a plurality of scales, predicting a corresponding probability of each token under the scale according to reference data corresponding to the scale, wherein the reference data comprises the target text;
determining a token prediction result of the scale according to sampling parameters and the corresponding probability of each token under the scale, wherein the sampling range indicated by the sampling parameters comprises a token prediction result of the scale;
updating the reference data corresponding to the scale according to the token prediction result of the scale, wherein the updated reference data comprises the token prediction result, and continuing to perform the step of predicting the corresponding probability of each token under the scale according to the reference data corresponding to the scale until a preset stop condition is reached; and
generating an image described by the target text according to the visual features indicated in the dictionary by the token prediction results of the plurality of scales.

15. The non-transitory computer-readable medium according to claim 14, wherein after the determining the token prediction result of the scale, the method further comprises:
updating the sampling parameters, wherein the sampling range indicated by the updated sampling parameters is smaller than that indicated by the sampling parameters before updating.

16. The non-transitory computer-readable medium according to claim 15, wherein the preset stop condition comprises that: the sampling range indicated by the sampling parameters before updating is not greater than a preset range threshold.

17. The non-transitory computer-readable medium according to claim 14, wherein the preset stop condition comprises that: the updating times of the reference data corresponding to the scale reach a preset times threshold.

18. The non-transitory computer-readable medium according to claim 14, wherein the updating the reference data corresponding to the scale according to the token prediction result of the scale comprises:
for any scale of a plurality of scales, if the scale is greater than a preset scale threshold, and/or the token prediction result of the scale comprises at least two tokens, the reference data corresponding to the scale is updated according to the token prediction result of the scale.

19. The non-transitory computer-readable medium according to claim 14, wherein the plurality of scales comprise a first scale and a second scale, the arrangement position of the first scale among the plurality of scales is adjacent to that of the second scale among the plurality of scales, and the arrangement position of the first scale among the plurality of scales is earlier than that of the second scale among the plurality of scales; and
the initial value of the reference data corresponding to the second scale is determined according to the target text and the token prediction result of the first scale.

20. The non-transitory computer-readable medium according to claim 14, wherein the image is generated using a decoder;
the decoder and the plurality of visual features are determined using the same training process.
